(19) United States
(12) Patent Application Publication
(10) Pub. No.: US 2025/0315212 A1
(43) Pub. Date: Oct. 9, 2025

(54) SYSTEMS AND METHODS FOR STORAGE AND DISTRIBUTION OF CERTIFIED RANDOMNESS

(71) Applicant: JPMORGAN CHASE BANK, N.A., New York, NY (US)

(72) Inventors: Pradeep NIROULA, College Park, MD (US); Ruslan SHAYDULIN, New York, NY (US); Shouvanik CHAKRABARTI, Jersey City, NJ (US); Omar AMER, New York, NY (US); Marco PISTOIA, Amawalk, NY (US); Andrew LANG, Avon, CT (US)

(21) Appl. No.: 18/625,633

(22) Filed: Apr. 3, 2024

(51) Int. Cl. G06F 7/58; G06N 10/60

(52) U.S. Cl. CPC G06F 7/582; G06N 10/60

(57) ABSTRACT

A method may include: (1) querying, by a randomness computer program executed by a randomness electronic device, a quantum randomness source for a plurality of sequences of random bits; (2) receiving, by the randomness computer program, the plurality of sequences of random bits; (3) saving, by the randomness computer program, the plurality of sequences of random bits in a randomness pool; (4) receiving, by the randomness computer program, a request for randomness from a client randomness computer program executed by a client electronic device; (5) drawing, by the randomness computer program, a subset of the plurality of sequences of random bits from the randomness pool; (6) marking, by the randomness computer program, the subset of the plurality of sequences of random bits as used; and (7) communicating, by the randomness computer program, the subset of the plurality of sequences of random bits to the client randomness computer program.

### BACKGROUND OF THE INVENTION

### 1. Field of the Invention

Embodiments relate to systems and methods for storage and distribution of certified randomness.

### 2. Description of the Related Art

Certain classical computer systems rely on the generation of random numbers to perform many functions, including password generation, market simulation, random user selection for promotion, etc. In order to increase the entropy of the random numbers by a local random number generator, U.S. Patent Application Publication Number 2022/0100473 to Aaronson proposes a classical computer client issuing a quantum circuit to a quantum computer system, and sampling the output of the quantum computer system multiple times. The disclosure of U.S. Patent Application Publication Number 2022/0100473 is hereby incorporated, by reference, in its entirety.

Classical computer systems often communicate over a public network, such as the Internet, with the quantum computer system. Thus, because each sample takes a certain amount of time, repeated samples can reach a time requirement that increases the possibility of an attack between the classical computer system and the quantum computer system. This is possible even with as little as 20 sequential samples.

### SUMMARY OF THE INVENTION

Systems and methods for storage and distribution of certified randomness are disclosed. According to an embodiment, a method may include: (1) querying, by a randomness computer program executed by a randomness electronic device, a quantum randomness source for a plurality of sequences of random bits; (2) receiving, by the randomness computer program, the plurality of sequences of random bits; (3) saving, by the randomness computer program, the plurality of sequences of random bits in a randomness pool; (4) receiving, by the randomness computer program, a request for randomness from a client randomness computer program executed by a client electronic device; (5) drawing, by the randomness computer program, a subset of the plurality of sequences of random bits from the randomness pool; (6) marking, by the randomness computer program, the subset of the plurality of sequences of random bits as used; and (7) communicating, by the randomness computer program, the subset of the plurality of sequences of random bits to the client randomness computer program.

In one embodiment, the randomness electronic device may include a server, the quantum randomness source may include a quantum computer, and the query may include a plurality of quantum circuits.

In one embodiment, the method may also include: associating, by the randomness computer program, an identifier with each of the plurality of sequences of random bits. The method may also include: communicating, by the randomness computer program, the identifier for each of the plurality of sequences of random bits in the subset of the plurality of sequences of random bits to the client randomness computer program.

In one embodiment, the method may also include: marking, by the randomness computer program, a time of drawing the subset of the plurality of sequences of random bits.

In one embodiment, the subset of the plurality of sequences of random bits may include the plurality of sequences of random bits stored in the randomness pool.

According to another embodiment, a method may include: (1) requesting, by a client randomness computer program executed by a client electronic device, randomness from a randomness computer program executed by a randomness electronic device; (2) receiving, by the client randomness computer program, a plurality of sequences of random bits from the randomness computer program; (3) storing, by the client randomness computer program, the plurality of sequences of random bits in a client randomness pool; (4) receiving, by the client randomness computer program, a request for one of the plurality of sequences of random bits from a client computer program executed by the client electronic device; (5) drawing, by the client randomness computer program, one of the sequences of random bits from the client randomness pool; (6) marking, by the client randomness computer program, the drawn sequence of random bits as used; and (7) communicating, by the client randomness computer program, the drawn sequence of random bits to the client computer program.

In one embodiment, the method may also include: determining, by the client randomness computer program, that there is an insufficient number of sequences of random bits in the client randomness pool; requesting, by the client randomness computer program, additional randomness from the randomness computer program; receiving, by the client randomness computer program, a second plurality of sequences of random bits from the randomness computer program; and storing, by the client randomness computer program, the second plurality of sequences of random bits in the client randomness pool.

In one embodiment, the randomness computer program receives the plurality of sequences of random bits from a quantum randomness source.

In one embodiment, the randomness electronic device may include a server and the quantum randomness source may include a quantum computer.

In one embodiment, the method may also include: receiving, by the client randomness computer program, an identifier for each of the plurality of sequences of random bits received from the randomness computer program. The method may also include: storing, by the client randomness computer program, a history of the identifiers received from the randomness computer program.

According to another embodiment, a method may include: (1) requesting, by a client randomness computer program executed by a client electronic device, a randomness seed from a randomness computer program executed by a randomness electronic device; (2) receiving, by the client randomness computer program, the randomness seed from the randomness computer program; (3) receiving, by the client randomness computer program, a request for a sequence of random bits from a client computer program executed by the client electronic device; (4) generating, by the client randomness computer program, the sequence of random bits using the randomness seed; and (5) communicating, by the client randomness computer program, the sequence of random bits to the client computer program.

In one embodiment, the randomness seed may have an expiration, and the expiration may be time based, use based, etc.

In one embodiment, the method may also include: requesting, by the client randomness computer program, a new randomness seed from the randomness computer program in response to the randomness seed expiring; and receiving, by the client randomness computer program, the new randomness seed from the randomness computer program. The sequence of random bits may be generated using the new randomness seed.

In one embodiment, the randomness computer program receives the randomness seed from a quantum randomness source.

In one embodiment, the randomness electronic device may include a server and the quantum randomness source may include a quantum computer.

In one embodiment, the method may also include: receiving, by the client randomness computer program, an identifier for the randomness seed received from the randomness computer program; and storing, by the client randomness computer program, a history of the identifier received from the randomness computer program.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for storage and distribution of certified randomness according to an embodiment;

FIG. 2 illustrates a method for storage and distribution of certified randomness according to an embodiment;

FIG. 3 illustrates a method for storage and distribution of certified randomness according to another embodiment;

FIG. 4 depicts an exemplary computing system for implementing aspects of the present disclosure.

### DETAILED DESCRIPTION OF PREFERRED EMBODIMENTS

Embodiments relate to systems and methods for storage and distribution of certified randomness, such as a sequence of random bits.

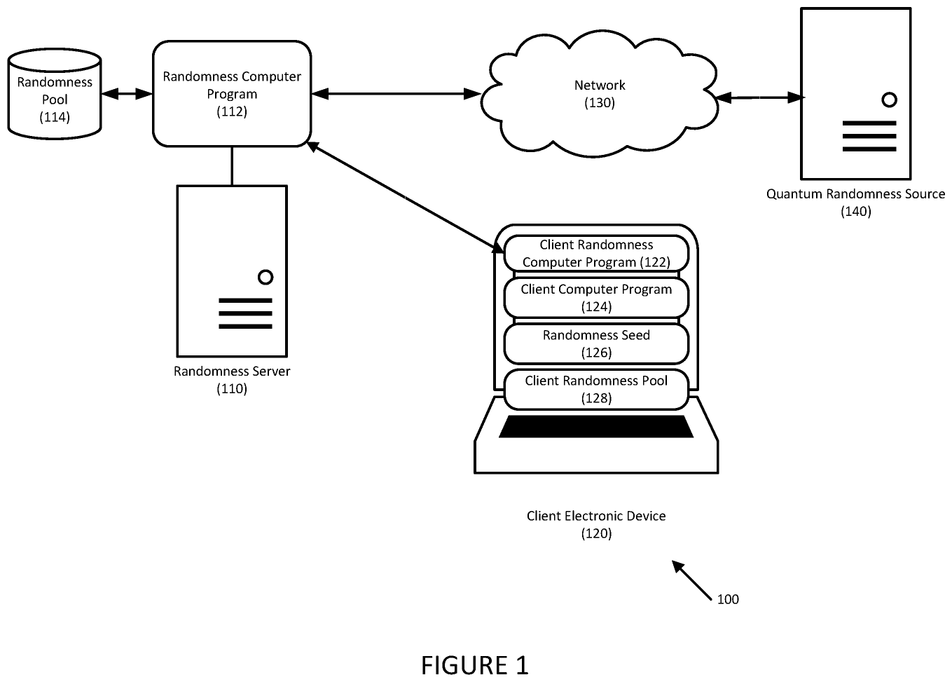

Referring to FIG. 1, a system for storage and distribution of certified randomness is disclosed according to an embodiment. System 100 may include randomness server 110, which may be one or more physical servers, a cloud-based server, a combination thereof, a computer (e.g., workstation, a desktop, a laptop, a notebook, etc.), a smart device (e.g., a smart phone, a smart watch, etc.), an Internet of Things (IoT) appliance, etc. Randomness server 110 may execute randomness computer program 112. Randomness computer program 112 may interface with quantum randomness source 140 over network 130 in order to generate sequences of random bits. Example of such interactions are disclosed in U.S. patent application Ser. No. 18/625,605, entitled “Systems And Methods For Certifying Randomness From Random Circuit Sampling On Quantum Processors With Low Clock Rates” to Ruslan Shaydulin et al., filed concurrently herewith, and in U.S. Patent Application Publication Number 2022/0100473, the disclosures of each of which is hereby incorporated, by reference, in its entirety. Other methods for generating sequences of random bits may be used as is necessary and/or desired.

Quantum randomness source 140 may be, for example, a quantum computer, and may provide randomness based on quantum states of qubits in the quantum computer.

Randomness computer program 112 may store the sequences of random bits in randomness pool 114, which may be any suitable data repository. Each sequence of random bits obtained from the random source is stored with a unique identifier, the query made to quantum randomness source 140, timestamps for when the query was made and when the sequence of random bits was received, a flag to indicate if the sequence of random bits has been used and a timestamp for the distribution, and any other information that is necessary and/or desired.

System 100 may further include client electronic device 120 that may execute client randomness computer program 122 and client computer program 124. Client electronic device 120 may be any suitable electronic device, including computers, smart devices, IoT devices, etc. Client randomness computer program 122 may determine if client randomness pool 128 has sequences of random bits for consumption by client computer program 124 to, for example, generate a password, execute a simulation (e.g., Monte Carlo simulation), etc. If there is not enough sequences of random bits, client randomness computer program 122 may request sequences of random bits from randomness computer program 112.

If randomness computer program 112 does not have sufficient sequences of random bits in randomness pool 114, it may generate sequences of random bits with quantum randomness source 140.

Certified randomness pool 128 may receive and store a block of sequences of random bits that may be consumed directly by client computer program 124.

In another embodiment, client electronic device 120 may receive one sequence of random bits and may store that as randomness seed 126. Client randomness computer program 122 may use a pseudorandom generator (not shown) with randomness seed 126 to generate additional sequences of random bits needed in its applications.

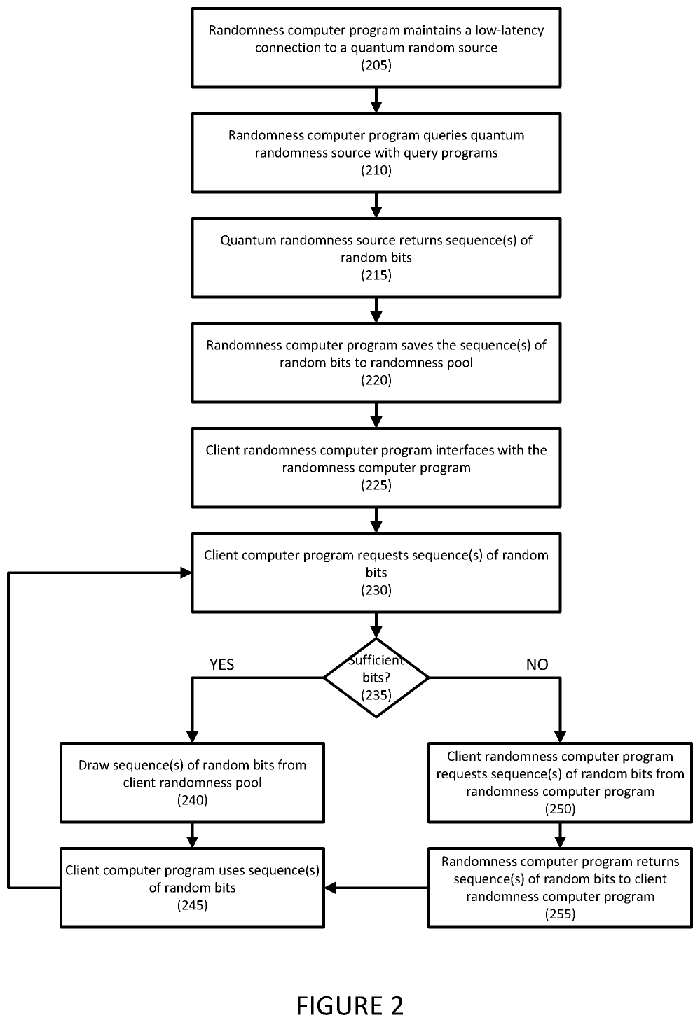

Referring to FIG. 2, a method for storage and distribution of certified randomness is disclosed according to an embodiment.

In step 205, a randomness computer program executed by a randomness server may maintain a low-latency connection to a quantum random source, such as a quantum computer.

In step 210, the randomness computer program may query the quantum randomness source with “query programs,” such as quantum circuits.

In step 215, in response to the query, the quantum randomness source may return sequences of random bits to the randomness computer program.

In step 220, the randomness computer program may save the sequences of random bits to a randomness pool. The sequences of random bits may be associated with a unique identifier, the query made to quantum randomness source 140, timestamps for when the query was made and when the sequences of random bits were received, a flag to indicate if the sequence of random bits has been distributed or used, a timestamp for the distribution, and any other information that is necessary and/or desired.

In one embodiment, the randomness computer program may check on the number of unused sequences of random bits in the randomness pool. The check may be continuous checks, periodic checks, with each request, etc. If the number of available sequences of random bits is below a threshold, the randomness computer program may query the source of quantum randomness for additional sequence of random bits.

In step 225, a client randomness computer program executed by a client electronic device may interface with the randomness computer program. The connection may be continuous or intermittent, as the client randomness computer program should be able to function offline for short times.

The client randomness computer program may maintain a client randomness pool comprising a block of sequences of random bits (e.g., sequences of random bits from the randomness computer program), and a history of the use of the certified randomness (e.g., a list of all the unique identifiers representing sequences of random bits the client randomness computer program has received).

In step 230, a client computer program may request randomness, such as one or more sequence of random bits, from the client randomness pool. In one embodiment, the request may be made to the client randomness computer program. In another embodiment, the client randomness computer program may monitor a message bus for requests by the client computer program for the sequence(s) of random bits.

In step 235, the client computer randomness program may determine whether there are a sufficient number of unused sequences of random bits in the client randomness pool.

If there are, in step 240, the client computer program may draw sequence(s) of random bits from the client randomness pool, and may mark the drawn sequence(s) of random bits as used. It may also include a timestamp for the draw.

In another embodiment, the client randomness computer program may draw the sequence(s) of random bits from the client randomness pool and return the sequence(s) of random bits to the client computer program. The client randomness computer program may then mark the drawn sequence(s) of random bits as used. It may also include a timestamp for the draw.

In step 245, the client computer program may use the sequence(s) of random bits as needed.

If the client randomness pool does not have sufficient sequences of random bits, in step 250, the client randomness computer program may request randomness, such as sequence(s) of random bits, from the randomness computer program.

In step 255, the randomness computer program may retrieve sequence(s) of random bits from the randomness pool and may return the bits to the client randomness computer program. If the randomness computer program does not have sufficient bits, it may interface with the quantum randomness source to generate certified randomness.

In one embodiment, the randomness computer program may provide a list of sequences of random bits with their unique identifiers and may note the time of distribution of each sequence.

The client randomness computer program may also note the time of reception in its history, may store the list of identifiers received from the randomness computer program, and may populate the client randomness pool with the sequence(s) of random bits.

As each sequence of random bits are used, the randomness computer program may mark the sequence of random bits as used with a timestamp. In one embodiment, it may further identify the client electronic device as the user of the sequence of random bits.

The process may then continue to step 245.

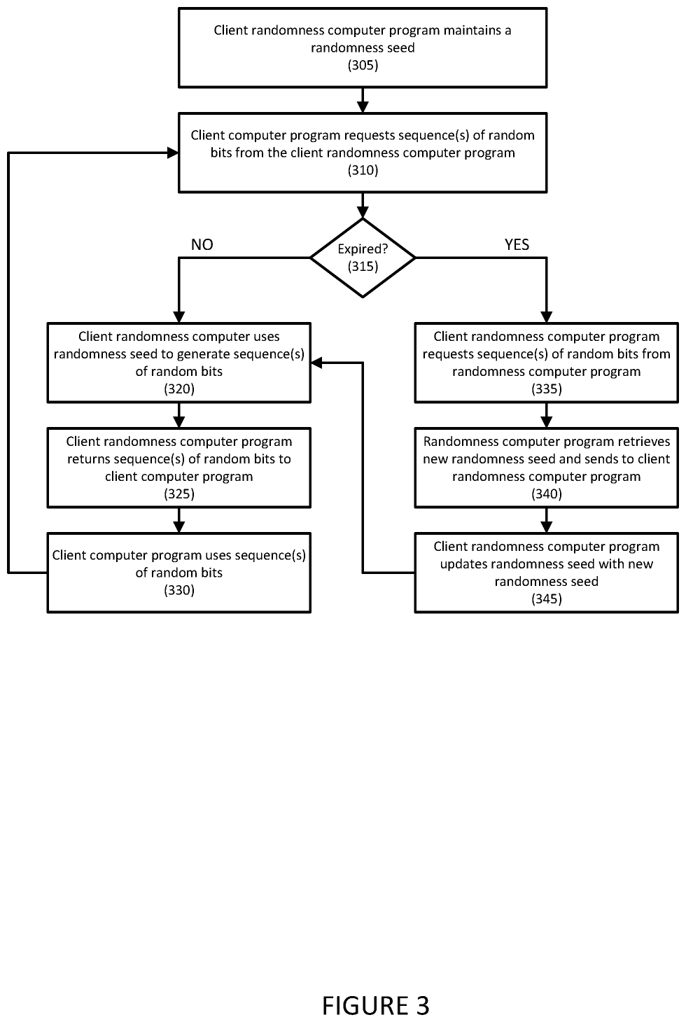

Referring to FIG. 3, a method for storage and distribution of certified randomness is disclosed according to another embodiment.

In step 305, a client randomness computer program executed by a client electronic device may maintain a randomness seed that may have an expiration. The expiration may be time-based (i.e., expires after a period of time), use-based (i.e., expires after a number of uses), application-based (e.g., specific to a computer application), etc.

In step 310, a client computer program executed by the client electronic device may request one or more sequences of random bits from the client randomness computer program.

In step 315, the client randomness computer program may check to see if the randomness seed has expired. If it has not expired, in step 320, the client randomness computer program may use the randomness seed to generate one or more sequences of random bits, and in step 325, may return the sequence(s) of random bits to the client computer program.

In step 330, the client randomness computer program may then use the sequence(s) of random bits as needed.

If, in step 315, the randomness seed has expired, in step 335, the client randomness computer program may make a call to the randomness computer program for a new randomness seed and timestamp.

In step 340, the randomness computer program may retrieve a new randomness seed (e.g., one sequence of random bits) and may send the needed randomness seed to the client randomness computer program. It may also mark the sequence of random bits as used.

In step 345, the client randomness computer program may update the randomness seed with the new randomness seed, and the process may continue to step 320.

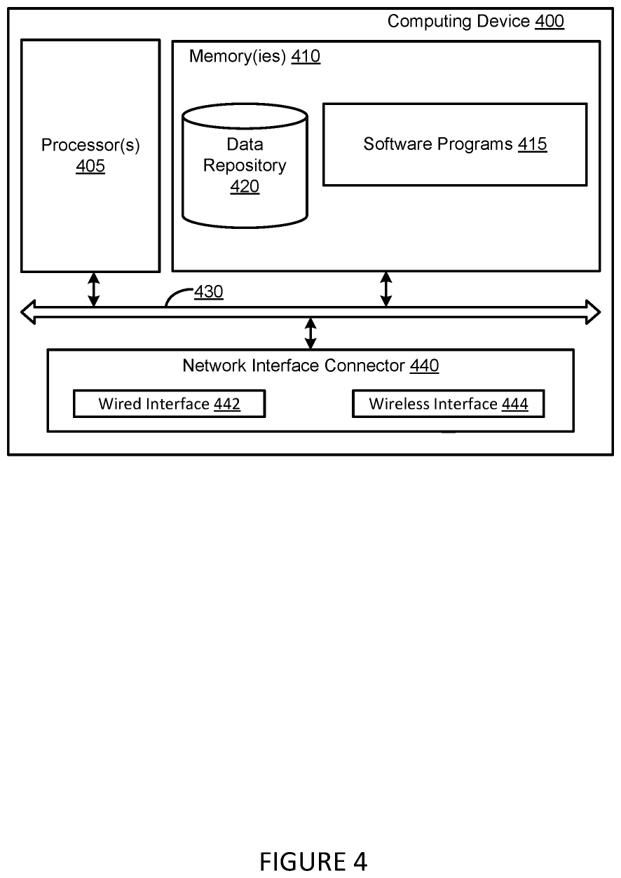

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
querying, by a randomness computer program executed by a randomness electronic device, a quantum randomness source for a plurality of sequences of random bits;
receiving, by the randomness computer program, the plurality of sequences of random bits;
saving, by the randomness computer program, the plurality of sequences of random bits in a randomness pool;
receiving, by the randomness computer program, a request for randomness from a client randomness computer program executed by a client electronic device;
drawing, by the randomness computer program, a subset of the plurality of sequences of random bits from the randomness pool;
marking, by the randomness computer program, the subset of the plurality of sequences of random bits as used; and
communicating, by the randomness computer program, the subset of the plurality of sequences of random bits to the client randomness computer program.

2. The method of claim 1, wherein the randomness electronic device comprises a server, the quantum randomness source comprises a quantum computer, and the query comprises a plurality of quantum circuits.

3. The method of claim 1, further comprising:
associating, by the randomness computer program, an identifier with each of the plurality of sequences of random bits.

4. The method of claim 3, further comprising:
communicating, by the randomness computer program, the identifier for each of the plurality of sequences of random bits in the subset of the plurality of sequences of random bits to the client randomness computer program.

5. The method of claim 1, further comprising:
marking, by the randomness computer program, a time of drawing the subset of the plurality of sequences of random bits.

6. The method of claim 1, wherein the subset of the plurality of sequences of random bits comprises the plurality of sequences of random bits stored in the randomness pool.

7. A method, comprising:
requesting, by a client randomness computer program executed by a client electronic device, randomness from a randomness computer program executed by a randomness electronic device;
receiving, by the client randomness computer program, a plurality of sequences of random bits from the randomness computer program;
storing, by the client randomness computer program, the plurality of sequences of random bits in a client randomness pool;
receiving, by the client randomness computer program, a request for one of the plurality of sequences of random bits from a client computer program executed by the client electronic device;
drawing, by the client randomness computer program, one of the sequences of random bits from the client randomness pool;
marking, by the client randomness computer program, the drawn sequence of random bits as used; and
communicating, by the client randomness computer program, the drawn sequence of random bits to the client computer program.

8. The method of claim 7, further comprising:
determining, by the client randomness computer program, that there is an insufficient number of sequences of random bits in the client randomness pool;
requesting, by the client randomness computer program, additional randomness from the randomness computer program;
receiving, by the client randomness computer program, a second plurality of sequences of random bits from the randomness computer program; and
storing, by the client randomness computer program, the second plurality of sequences of random bits in the client randomness pool.

9. The method of claim 7, wherein the randomness computer program receives the plurality of sequences of random bits from a quantum randomness source.

10. The method of claim 9, wherein the randomness electronic device comprises a server and the quantum randomness source comprises a quantum computer.

11. The method of claim 7, further comprising:
receiving, by the client randomness computer program, an identifier for each of the plurality of sequences of random bits received from the randomness computer program.

12. The method of claim 11, further comprising:
storing, by the client randomness computer program, a history of the identifiers received from the randomness computer program.

13. A method, comprising:
requesting, by a client randomness computer program executed by a client electronic device, a randomness seed from a randomness computer program executed by a randomness electronic device;
receiving, by the client randomness computer program, the randomness seed from the randomness computer program;
receiving, by the client randomness computer program, a request for a sequence of random bits from a client computer program executed by the client electronic device;
generating, by the client randomness computer program, the sequence of random bits using the randomness seed; and
communicating, by the client randomness computer program, the sequence of random bits to the client computer program.

14. The method of claim 13, wherein the randomness seed has an expiration.

15. The method of claim 14, wherein the expiration is time based.

16. The method of claim 14, wherein the expiration is use based.

17. The method of claim 14, further comprising:
requesting, by the client randomness computer program, a new randomness seed from the randomness computer program in response to the randomness seed expiring; and
receiving, by the client randomness computer program, the new randomness seed from the randomness computer program;
wherein the sequence of random bits is generated using the new randomness seed.

18. The method of claim 13, wherein the randomness computer program receives the randomness seed from a quantum randomness source.

19. The method of claim 18, wherein the randomness electronic device comprises a server and the quantum randomness source comprises a quantum computer.

20. The method of claim 13, further comprising:
receiving, by the client randomness computer program, an identifier for the randomness seed received from the randomness computer program; and
storing, by the client randomness computer program, a history of the identifier received from the randomness computer program.
